(19) United States
(12) Patent Application Publication
(10) Pub. No.: US 2002/0160792 A1
(43) Pub. Date: Oct. 31, 2002

(54) Device for cordlessly interfacing a computer with a phone line

(76) Inventor: Larry G. Maki, Conestogo (CA)

Correspondence Address: DARYL W SCHNURR, BARRISTER & SOLICITOR, PO BOX 2607, 18 WEBER STREEST WEST, KITCHENER, ONTARIO, N2H 6N2, CA

(21) Appl. No.: 10/131,383

(22) Filed: Apr. 25, 2002

Related U.S. Application Data
(60) Provisional application No. 60/286,232, filed on Apr. 26, 2001.

(51) Int. Cl. H04Q 7/20

(52) U.S. Cl. 455/462; 455/557

(57) ABSTRACT

A device and method of operation thereof for cordlessly interfacing a computer with a phone line uses the standard modem port of the computer. The device uses the standard base of a cordless phone and preferably uses the standard handset to the cordless phone. An interface portion is added to the handset and is connected into the standard modem port of the computer. The interface portion causes the handset to simulate a standard telephone line to the computer and a conventional headset to the cordless phone.

### BACKGROUND OF THE INVENTION

1. Field of Invention

This invention relates to a device for cordlessly interfacing a computer with a phone line using the standard modem port of the computer and a method of operation thereof. More particularly, this invention relates to a device for interfacing a computer with a phone line where the device is largely a cordless phone with an interface attachment connected to the handset portion of the cordless phone.

2. Description of the Prior Art

Portable laptop or notebook computers are often used to access the Internet. The Internet access usually requires a wired connection to a telephone line or a table modem. For example, when a notebook computer is used to access the Internet through a phone line, the notebook computer is wired directly or indirectly into a jack of the phone line. When the notebook computers are connected to the phone line their mobility is greatly restricted as the computer must be used in close proximity to a phone jack. If the connection between the computer modem and the phone jack is cordless, the mobility advantages of using a notebook computer within the home or office can be extended to Internet use.

Since these notebook computers are designed to be portable, they can and are being used at many points around the home. For example:

In the family room to be near the family,

In an entertainment area to be able to watch a program while also using the notebook,

On the outdoor patio on a fine day,

In bed last thing at night.

It is desired that much of this around-the-home use involve Internet access, to perform e-mail, look up information, shop on-line, be entertained, and so on. However, this is usually severely hampered by the requirement of a wired connection, which may not be available at various locations, or even if so, is inconvenient to connect and disconnect, and to contend with the long cables. These are the same restrictions that have made cordless phones so popular for voice communications via phone.

Solutions to this problem do exist in the form of Wireless LAN (Local Area Network) devices. These involve fitting a board or module within or near the computer, and at least one more device which may be connected to another, usually fixed PC, and through it to a phone or cable line. However, these solutions are relatively expensive (in the hundreds of dollars), complex and relatively difficult to install. These systems are intended to perform high-speed networking between computers, and not just simple/lowcost Internet access. Therefore, these systems are more suitable for businesses or for use in schools than for home consumers or small businesses and have not been as successful with consumers as, for example, cordless phones have been. Cordless phones are relatively inexpensive compared to the cost of previous solutions to this problem.

Most PC's now already have a modem installed, and this is usually terminated in a standard modem port usually involving a standard RJ-11 telephone jack. This port and jack is usually used for standard wired Internet access.

In U.S. Pat. No. 6,128,510 naming Beukema et al as inventors, issued on Oct. 3, 2000, there is described a cordless connection for a data/fax modem. This patent states that one cannot simply connect a modem to a cordless telephone because the conversational voice data and computer modem data have different bandwidths, signal fidelity requirements and security requirements. The Beukema et al patent proposes the use of separate electronic channels for voice and data communication and circuitry to differentiate between voice and data. The two channels permit the differences between voice and data transmission to be dealt with separately. The solution proposed by Beukema et al is very expensive compared to the present invention.

In U.S. Pat. No. 6,006,109 naming Shin as inventor, and issued on Dec. 21, 1999, there is described a means of connecting a portable phone (i.e. a cell phone) to a computer modem using the microphone and headphone jacks of the computer rather than using the standard modem port. This design requires modifications to the computer itself and requires additional circuitry within the computer and so is not a practical solution for the end consumer. In addition to the expense of the product itself, most consumers will have to pay an installer to install the system.

### SUMMARY OF THE INVENTION

It is an object of the present invention to provide a single channel device and a method of operation thereof for cordlessly interfacing a computer with a phone line. It is a further object of the present invention to provide a device and a method of operation thereof for cordlessly interfacing a computer with a phone line without meeting higher fidelity standards than a conventional cordless phone. Still further, it is an object of the present invention to provide a device and a method of operation thereof for cordlessly interfacing a computer with a phone line through the standard modem port of the computer where the free set and the base of the device have one channel.

A device for cordlessly interfacing a computer with a phone line, where the computer has a standard modem port, has a base and a free set. The base has a first power source and is wired to a phone line. The free set has a second power source and is completely separable from the base with no wires extending between the free set and the base. The free set has a connector thereon for connecting the free set to the standard modem port of the computer. The free set and the base each have transmitting means and receiving means to enable electronic signals to pass between the base and the free set to allow the computer to be used for Internet access. When the free set is connected to the computer even though there are no wires extending between the free set and the base and the free set is separate and apart from the base but within a maximum range whereby electronic signals can be passed between the free set and the base. The free set and the base have one electronic channel.

A method of cordlessly interfacing a computer with a phone line uses a standard modem port of the computer and a device having a base and a free set. The base and free set each have a transmitter and a receiver to enable electronic signals to pass between the base and the free set even when the base and free set are separate and apart from one another, with no wires extending between them. The base has a first power source and the free set has a second power source. The base is wired to a phone line and the free set has a connector thereon for connecting the free set to the standard modem port of the computer. The method comprises choosing a base for a standard cordless phone, constructing a free set that can communicate with the base, connecting the free set to the computer by inserting the connector into the standard modem port of the computer, constructing electronic circuitry within the free set to simulate a phone line to the computer and to simulate an ear piece line and a mouth piece line to the base, operating the computer to attain Internet access through the free set when the free set is separate and apart from the base with no wires connecting the base and the free set.

### BRIEF DESCRIPTION OF THE DRAWINGS

FIG. 1 shows a schematic block diagram of a device for cordlessly interfacing a computer with a phone line;

FIG. 2 shows a further embodiment of a schematic block diagram of a device for cordlessly interfacing a computer with a phone line;

FIG. 3 is a simplified schematic circuit diagram of an interface portion of a device for interfacing a computer with a phone line in accordance with the present invention; and

FIG. 4 is a simplified partial schematic circuit diagram of an interface portion without transformers.

### DESCRIPTION OF A PREFERRED EMBODIMENT

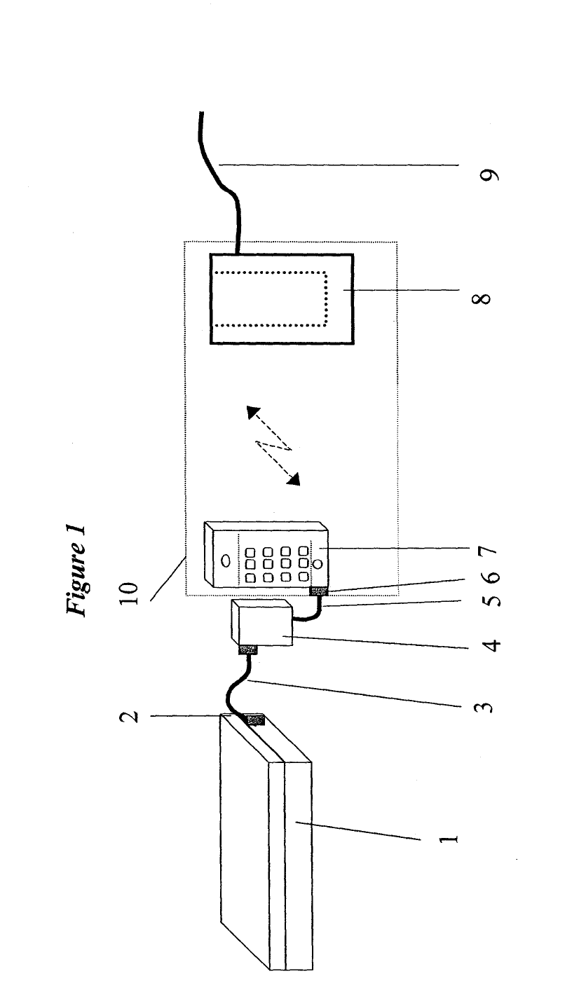

In FIG. 1, there is shown a portable laptop or notebook computer 1 having a standard modem port 2. A short connector 3, which is typically a few inches long, couples the modem port 2 to an interface portion 4. The interface portion 4 is in turn connected by a cable 5 to a standard handset of a cordless phone 7. The handset of the cordless phone 7 and the interface portion 4 together comprise a free set. The interface portion 4 converts the signals on the standard modem port 2 to a form that is compatible with a headset jack 6 of the handset 7 of the standard cordless phone.

A base 8 is connected into a phone line 9. The base 8 is preferably a conventional base for a standard cordless phone. The handset 7 is preferably a conventional handset for a cordless phone. The base 8 has a power source (not shown) which is preferably an electrical wire plugged into an electrical outlet (not shown). The free set communicates with the base even though there are no wires connecting the free set to the base. The free set and base have one electronic channel. Of course, the free set must be within a maximum range whereby electronic signals can be passed between the free set and the base. The free set and the base have one electronic channel. Preferably, the free set is powered by rechargeable batteries and, more preferably, the rechargeable batteries automatically recharge when the free set is placed in a predetermined position on the base. Alternatively, the rechargeable batteries should be automatically recharged when the free set is connected to the portable computer. In the further alternative, the second power source of the free set could be the power source of the portable computer. The free set and the base each have transmitting and receiving means (not shown in FIG. 1) to enable electronic signals to pass between the base and the free set to allow the computer to be used for Internet access when the free set is connected to the computer as shown in FIG. 1. The maximum range is the same range that is achievable with a conventional cordless phone. The actual range will vary with the particular base and free set that is used, but the maximum range is generally considered to be a few hundred feet.

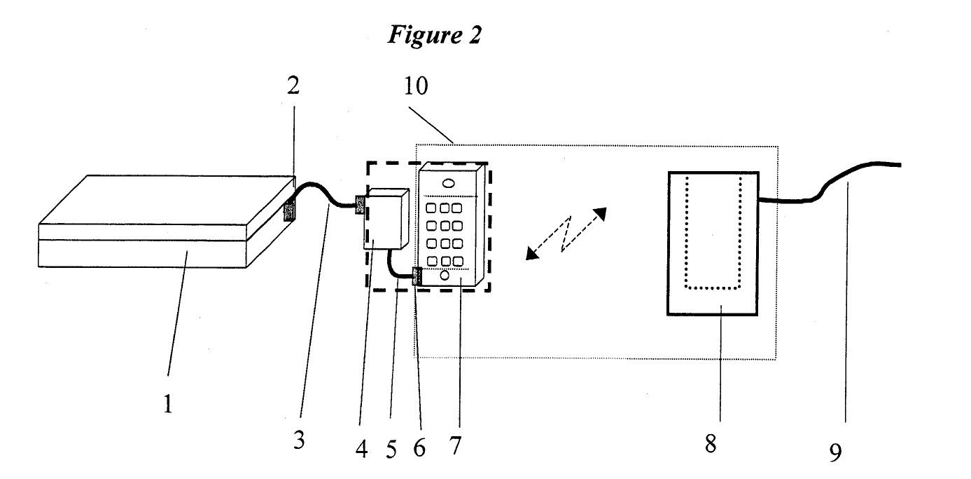

In FIG. 2, the same reference numerals are used as those used in FIG. 1 to describe those components that are identical to the components of FIG. 1. In FIG. 1, the interface portion 4 is an add on to the standard handset 7 of the cordless phone. In FIG. 2, the interface portion 4 is integral with the standard handset 7 to form a free set 10. The portable computer and the cordless phone portions of the invention are conventional and are therefore not described in detail. The interface portion 4 accomplishes the following:

(a) to the portable notebook computer, the interface portion 4 appears to be a standard telephone line in every way;

(b) to the handset 7 of the cordless phone, the interface portion 4 appears to be a conventional headset of a cordless phone; and

(c) the interface portion 5 transfers audio signaling between the notebook computer and the cordless phone.

The cordless phone includes the base 8 and the handset 7. An advantage of the present invention is that cordless phones are relatively inexpensive and are widely used and popular with consumers. A consumer can use the device of the present invention for cordlessly interfacing a computer with a phone line simply by connecting the interface portion into the headset connector of the standard handset of the cordless phone and also into the standard modem port of the computer. Preferably, the computer and the free set will have corresponding attachment means thereon so that the free set can be readily removably attached to the housing of the computer so that when the computer is supported by the user, the free set is also supported. If the device of the present invention is used as an attachment, when the device is disconnected from the hand set, the cordless phone can be used as a standard cordless phone.

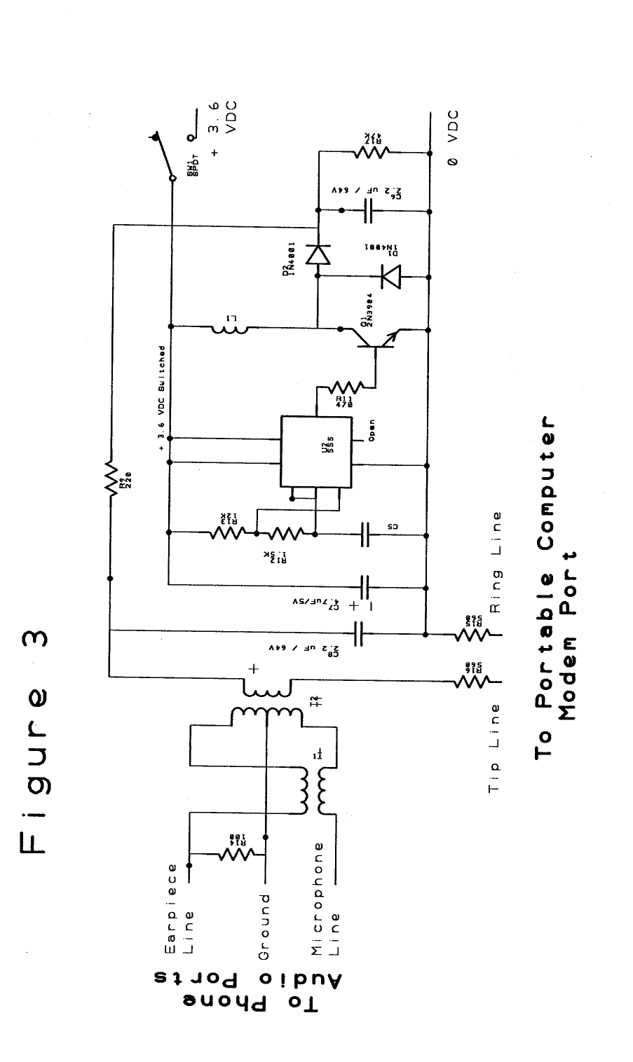

In FIG. 3, there is shown a schematic circuit diagram for the interface portion 4.

The interface of the notebook computer is provided with standard telephone DC signal levels by means of a DC-DC converter (U2, Q3, L1, D1, D2 and C6) and related parts. U2 is a conventional oscillator, which drives Q1 in storing energy in L1 and then releasing it in the correct time ratio to provide a high voltage to D2 and C6. This circuit provides a DC level of approximately 48 volts when there is an open circuit between the ‘tip’ and ‘ring’ lines, and a series resistance of approximately 1,500 ohms, both of which are typical of a normal phone line.

The portable computer port is also provided with a 2-wire audio signaling in which both receive and transmit signals appear on the same pair of wires, as is required on a normal phone line. The combination of R9 and C8 provide filtering of noise from the DC-DC converter to ensure it does not enter the notebook or the phone line.

The combination of transformers T1 and T2 convert the signal from 2-wire to 3-wire form, as is required to separate the signals so they match the separate ‘ear-piece out’ and ‘microphone in’ connections of the cordless phone's standard headset jack. In more detail, transformer T2 provides two separate signal lines, while transformer T1 ensures that signals progressing from the ear-piece line to the portable computer are not transmitted back onto the microphone line.

T1 accomplishes this by inserting a signal in the microphone line that exactly opposes that which would appear if T1 were not present, and the sum of these two signals is zero, ensuring no ear-piece line signals appear in the microphone line.

R14 simulates the impedance of a standard ear-piece to the cordless phone.

The circuit is such that it can be powered by a small rechargeable battery for many hours.

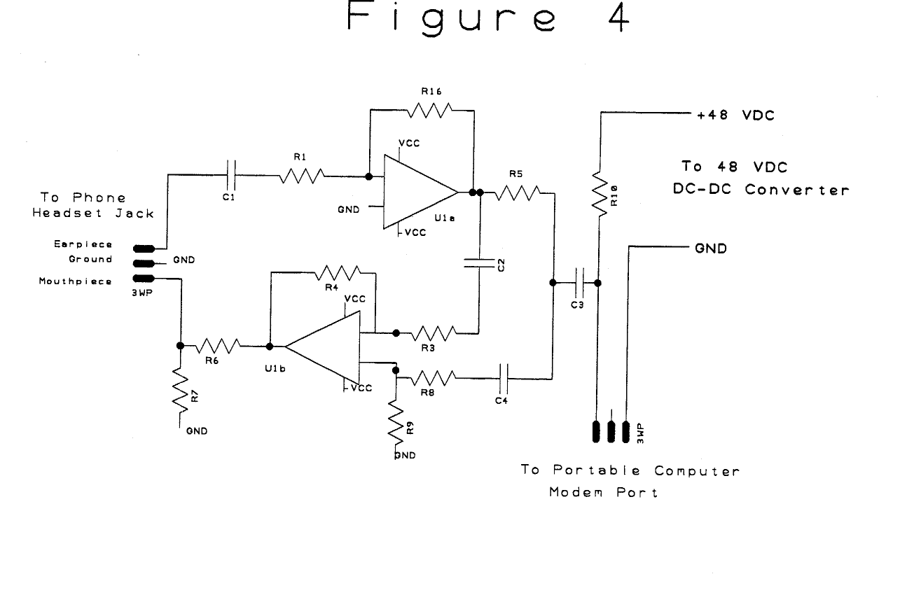

Other embodiments of the interface device, including those requiring no transformers, are possible and have been used successfully. In place of transformers, the interface portion uses analog operational amplifier circuitry to accomplish the same function. This results in a smaller overall device. A partial schematic circuit diagram of an interface device without transformers is shown in FIG. 4. The right hand portion of the circuit has been omitted from FIG. 4 but is the same as the right hand portion of the circuit shown in FIG. 3. The figure shows the portion of the interface device that interfaces the audio signaling from the phone headset jack to the modem port of the portable computer. It consists of a normal operational amplifier, which amplifies the signal level at the ear piece to that which simulates normal modem receive levels.

In the reverse path, a second operational amplifier (shown at bottom of figure) converts signal levels which normally appear at the send end of a modem to the level simulating that of a normal microphone/mouth piece level. In addition, this operational amplifier cancels out signals which originate from the ear piece line via the network of R3, C2 and R5, so that echo-back effects are reduced to a satisfactory level.

Since the modem of the portable computer is designed to work with standard telephone lines, the modem expects a DC signal of approximately 48 volts DC when starting out at off-hook. The modem expects a holding current in the region of 10 milliamps when it connects to the off-hook position. The inverter circuit based around the TLC555 provides these conditions and therefore simulates a phone line to the modem of the computer. The circuit of the interface portion 4 can be powered from a standard low cost rechargeable battery of the type used in the handsets of cordless phones. Alternatively, the interface portion 4 may be powered from the cordless phones own rechargeable battery by means of the interface circuit. When the interface portion 4 is integral with the handset of the cordless phone to form a free set, it is preferred that the free set has one power source. It is also feasible to integrate the interface portion 4 into a circuit for the handset of a standard cordless phone while eliminating much of the handset hardware. For example, the push button on the handset can be eliminated.

It is preferable to eliminate the use of transformers by using analog operational amplifier circuitry to accomplish the same functions, thereby resulting in a smaller overall device. While the device of the present invention is most advantageously used with portable computers, it can also be used to cordlessly connect desk top computers to the Internet.

The maximum range or distance that the free set can be located from the base and still communicate with the base is the same as the maximum range or distance that can be achieved with a cordless phone. The actual distance will vary in particular circumstances relating to the location of the device. For example, other devices located in the same premises such as a cordless phone, might interfere with the communication between the free set and the base if the free set is moved too far from the base. Most cordless phone have a range of a few hundred feet and can be used outside the premises in which the base is located. Generally, the range of a standard cordless phone can be considered to be greater than two hundred feet and less than three hundred feet. The device of the present invention will have the same range.

I claim:

1. A device for cordlessly interfacing a computer with a phone line where said computer has a standard modem port, said device comprising a base and a free set, said base having a power source and being wired to a phone line, said free set being battery powered, said free set being completely separable from said base with no wires extending between said free set and said base, said free set having a connector thereon for connecting said free set to said standard modem port of said computer, said free set and said base each having transmitting means and receiving means to enable electronic signals to pass between said base and said free set to allow said computer to be used for internet access when said free set is connected to said computer even though there are no wires extending between said free set and said base and said free set is separate and apart from said base but within a predetermined maximum range whereby electronic signals can be passed between said free set and said base.

2. A device as claimed in claim 1 wherein the free set is powered by rechargeable batteries, said batteries automatically recharging when said free set is placed in a predetermined position on said base.

3. A device as claimed in claim 1 wherein the base is a standard base of a cordless phone connected to an electrical outlet and part of the free set is a standard handset portion of a cordless phone with an interface attachment connected to the handset portion, said interface attachment having a connector thereon for connecting said interface attachment to the standard modem port of the computer.

4. A device as claimed in claim 1 wherein the computer is a laptop computer.

5. A device as claimed in claim 1 wherein said free set has a DC-DC converter whereby the computer detects a signal of approximately 48 volts when a dial tone is available in the phone line and a series resistance of approximately 1500 ohms.

6. A device as claimed in claim 1 wherein the free set is constructed to provide the computer with a two-wire audio signal in which both receive and transmit signals appear on the same pair of wires.

7. A device as claimed in claim 5 wherein there are filters to filter noise from the DC-DC converter.

8. A device as claimed in claim 6 wherein there are two transformers to convert the signal from a two-wire form to a three-wire form so that said signals appear to the base to be compatible with the signals of a standard handset of a cordless phone.

9. A device as claimed in claim 6 wherein there is a first transformer to provide two separate signal lines to match an ear-piece out line and a microphone in line of a standard handset of a cordless phone and a second transformer to ensure that signals progressing from the ear-piece line to the computer are not transmitted back on to the other microphone line.

10. A device as claimed in claim 9 wherein the second transformer is connected to insert a signal in the microphone line that exactly opposes the signal that would appear if the first transformer were not present, thereby ensuring that no ear-piece line signals appear in the microphone line.

11. A device as claimed in claim 6 wherein a resistor in an electronic circuit of the free set simulates the impedance of a standard ear-piece of a cordless phone to the base.

12. A device as claimed in claim 6 wherein there are no transformers.

13. A device as claimed in claim 1 wehrein a maximum distance in said range is a few hundred feet.

14. A method of cordlessly interfacing a computer with a phone line using a standard modem port of said computer and a device having a base and a free set, said free set having a connector to connect to said standard modem port, said base and free set each having a transmitter and a receiver to enable electronic signals to pass between said base and said free set even when said base and said free set are separate and apart from one another, with no wires extending between them, said base having a first power source and the free set having a second power source, said base being wired to a phone line, said free set having a connector thereon for connecting the free set to said standard port of the computer, said method comprising choosing a base of a standard cordless phone and constructing a free set that can communicate with said base, connecting said free set to said computer by inserting said connector into the standard modem port of the computer, constructing electronic circuitry within the free set to simulate a phone line to the computer and to simulate an ear-piece line and a mouth-piece line to the base, operating the computer to attain internet access through the free set when the free set is separate and apart from the base with no wires connecting the base and the free set.

15. A method of cordlessly interfacing a computer with a phone line using a standard modem port of said computer and a device having a base and a free set, said free set having a connector to connect to said standard modem port, said base and free set each having a transmitter and a receiver to enable electronic signals to pass between said base and said free set even when said base and said free set are separate and apart from one another, with no wires extending between them, said base having a first power source and the free set having a second power source, said base being wired to a phone line, said free set having a connector thereon for connecting the free set to said standard port of the computer, said method comprising choosing a base of a standard cordless phone and a handset for a standard cordless phone corresponding to said base, said handset having a headset outlet thereon, connecting an interface portion to the handset, said interface portion having a connector thereon, connecting the connector into the standard modem port of the computer, said interface portion and handset together forming a free set, constructing electronic circuitry within the Internet portion to simulate a phone line to the computer and to simulate an ear piece line and a mouth piece line to the base, operating the computer to attain Internet access through the free set when the free set is separate and apart from the base with no wires connecting the base and the free set.

16. A method as claimed in claim 15 including the step of connecting the interface portion to the headset outlet of the handset.
